(19) United States
(12) Patent Application Publication
(10) Pub. No.: US 2025/0165402 A1
(43) Pub. Date: May 22, 2025

(54) Memory-Access Policies in Peripheral Device based on Memory Usage Characteristics

(71) Applicant: Mellanox Technologies, Ltd., Yokneam (IL)

(72) Inventors: Ran Avraham Koren, Haifa (IL); Daniel Marcovitch, Yokneam Illit (IL); Gal Shalom, Givat-Avni (IL); Ariel Shahar, Jerusalem (IL)

(21) Appl. No.: 18/513,563

(22) Filed: Nov. 19, 2023

(51) Int. Cl. G06F 12/0862; G06F 12/0831; G06F 13/16

(52) U.S. Cl. CPC G06F 12/0862; G06F 12/0835; G06F 13/1663

(57) ABSTRACT

A system includes a processing device and a peripheral device. The processing device is to assign a memory region in a memory. The peripheral device is to set a memory-access policy responsively to usage characteristics of the memory region, and to access data in the memory region using Direct Memory Access (DMA) in accordance with the memory-access policy.

### FIELD OF THE INVENTION

The present invention relates generally to computing systems, and particularly to memory access by peripheral devices.

### BACKGROUND OF THE INVENTION

Computing systems often comprises a peripheral device that is connected to a host via a peripheral bus. Peripheral devices may comprise, for example, network adapters, storage devices, accelerators and Graphics Processing Units (GPUs). Peripheral buses, also referred to as system buses, may comprise, for example, Peripheral Component Interconnect Express (PCIe), Advanced Extensible Interface (AXI), Compute Express Link (CXL), Nvlink or Nvlink Chip-to-Chip (Nvlink-C2C). In many computing systems, after initial memory registration, a peripheral device is capable of accessing memory regions in a memory of the system directly using Direct Memory Access (DMA).

### SUMMARY OF THE INVENTION

An embodiment of the present invention that is described herein provides a system including a processing device and a peripheral device. The processing device is to assign a memory region in a memory. The peripheral device is to set a memory-access policy responsively to usage characteristics of the memory region, and to access data in the memory region using Direct Memory Access (DMA) in accordance with the memory-access policy.

In an embodiment, the processing device is to provide to the peripheral device context information describing the memory region, and the peripheral device is to access data in the memory region in accordance with the context information. In some embodiments, the memory-access policy specifies a caching policy for caching, in the peripheral device, portions of the data or portions of context information describing the memory region. In some embodiments, the memory-access policy specifies a prefetching policy for prefetching, in the peripheral device, portions of the data or portions of context information describing the memory region.

In example embodiments, the usage characteristics include one or more of: a pattern of addresses that characterizes access to the memory region, an access frequency that characterizes access to the memory region, an access direction that characterizes access to the memory region, a location of the memory region, and whether the memory region is pinned or unpinned.

In some embodiments, the peripheral device is to deduce the usage characteristics by tracking memory-access transactions performed in the memory region. Additionally or alternatively, the processing device is to generate a hint that is indicative of the usage characteristics of the memory region and to provide the hint to the peripheral device, and the peripheral device is to set the memory-access policy responsively to the hint.

In some embodiments, the processing device is to select the hint from a defined set of hints, and the peripheral device is to select the memory-access policy from a defined set of memory-access policies. In an example embodiment, one or both of the processing device and the peripheral device are to adaptively modify one or more of: one or more of the hints, one or more of the memory-access policies, and a mapping between the hints and the memory-access policies.

In a disclosed embodiment, the memory-access policy, and a mapping between the hint and the memory-access policy, are internal to the peripheral device and are not accessible to the processing device. In another embodiment, one or both of the processing device and the peripheral device are to provide an Application Programming Interface (API) for specifying one or more of: the hint, the memory-access policy, and a mapping between the hint and the memory-access policy. In yet another embodiment, the hint is an ad-hoc hint that is valid for a defined time period or for one or more memory-access transactions to be performed in the memory region.

There is additionally provided, in accordance with an embodiment of the present invention, a method including, using a processing device, assigning a memory region in a memory. In a peripheral device, a memory-access policy is set responsively to usage characteristics of the memory region, and data is accessed in the memory region using Direct Memory Access (DMA) in accordance with the memory-access policy.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system comprising a host, a peripheral device and a memory, in accordance with an embodiment of the present invention;

FIGS. 2 and 3 are flow charts that schematically illustrates methods for setting a memory-access policy in the peripheral device of FIG. 1, in accordance with embodiments of the present invention; and

FIG. 4 is a block diagram that schematically illustrates additional details of the host and the peripheral device, and of setting memory-access policies, in accordance with an embodiment of t the present invention.

### DETAILED DESCRIPTION OF EMBODIMENTS

### Overview

In some computing systems, a host or other processing device provides a peripheral device with the capability to access memory regions directly using DMA. For example, a network adapter may read data directly from system memory in order to generate outgoing packets for transmission. Similarly, a network adapter may write data received in incoming packets, directly to the system memory. Other types of peripheral devices, such as storage devices or graphics accelerators, may also write and read data to and from the system memory using DMA, without involving the host in the data transfer.

In an example implementation, to enable the peripheral device to access a memory region directly, the host and the peripheral device carry out a process referred to as “memory registration”. As part of the memory registration process, the host provides the peripheral device with metadata, referred to as a “context”, which describes the memory region. The context may comprise, for example, a mapping between virtual addresses and physical addresses to be used by the peripheral device. Once the memory region has been registered, the host typically issues memory-access commands (e.g., read and write commands) to the peripheral device, but the actual data transfer is carried out directly between the peripheral device and the memory.

Different memory regions may differ from one another considerably in the way they are used by the host, and therefore in the manner the peripheral device is required to access them. For example, some memory regions may be accessed in a sequential manner, other memory regions may be accessed with some periodic or otherwise predictable pattern, and yet other memory regions may be accessed in a random manner. Some memory regions are mostly read from, whereas other memory regions are mostly written to. Some memory regions are accessed frequently, whereas other memory regions may be accessed rarely, or only once. In the present context, characteristics indicative of the manner in which a memory region is accessed, such as the above examples, are referred to herein as “usage characteristics” of a memory region. Additional examples are discussed further below.

The usage characteristics of memory regions can be valuable to the peripheral device in managing memory access, e.g., in deciding on operations such as caching and prefetching. For example, data caching provides considerable performance improvement in a memory region that is accessed frequently. In a memory region that is read only once, on the other hand, data caching does not improve performance and unnecessarily wastes memory resources. As another example, prefetching of data is highly effective in a memory region that is accessed sequentially, but practically useless when the memory is accessed randomly.

Conventionally, peripheral devices have no prior information as to the usage characteristics of the memory regions they are required to access. This lack of information prevents peripheral devices from optimizing their memory access operations.

Embodiments of the present invention that are described herein provide improved techniques for memory access by peripheral devices. In the disclosed embodiments, the peripheral device is made aware of the usage characteristic of a memory region. The peripheral device sets s a memory-access policy for accessing the memory region based on the usage characteristics.

The peripheral device can acquire information as to the usage characteristics of a memory region in various ways. In some embodiments, the host (or some other processing device external to the peripheral device) sends the peripheral a “hint” that is indicative of the usage characteristics. Various types of hints are described herein. In other embodiments, the peripheral device learns the usage characteristics regardless of any hints, by tracking memory-access transactions performed in the memory region. The latter embodiments can be used with legacy hosts that do not support the disclosed techniques.

In various embodiments, the peripheral device may set various kinds of memory-access policies, e.g., caching policies and/or prefetching policies, based on the usage characteristics of the memory region.

In some embodiments, the peripheral device holds (i) a list of possible hints, (ii) a list of possible memory-access policies, and (iii) a mapping between the hints and policies. Upon receiving a certain hint from the host, the peripheral device selects the appropriate memory-access policy based on the mapping. The hints, the policies, and/or the mapping between them, may be user-configurable and/or may vary over time.

In some embodiments, the policies and the hints-to-policies mapping are not exposed to the host. Such embodiments are useful, for example, for maintaining data privacy and security in a peripheral device that serves multiple different hosts.

The disclosed techniques enable a peripheral device to match memory-access operations (e.g., caching and prefetching) to actual usage characteristics, per memory region. As a result, computation and memory resources of the peripheral device can be used more efficiently.

### System Description

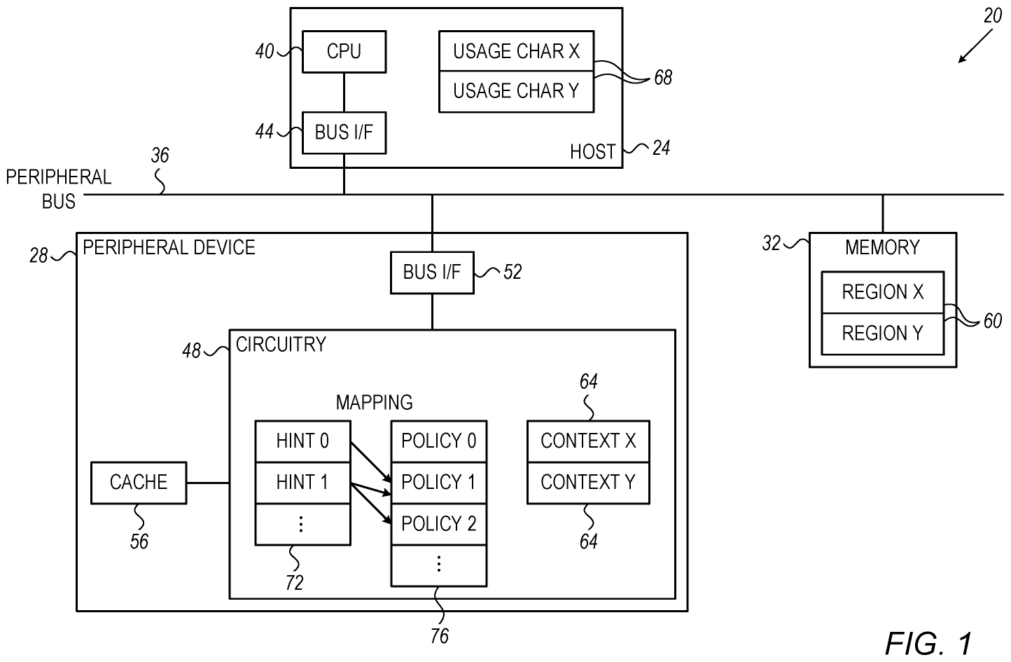

FIG. 1 is a block diagram that schematically illustrates a computing system 20, in accordance with an embodiment of the present invention. System 20 comprises a processing device, in the present example a host 24, a peripheral device 28 and a memory 32, all connected to a peripheral bus 36.

In the embodiment of FIG. 1, host 24 comprises a Central Processing Unit (CPU) 40 that carries out the various computation tasks of the host, and a bus interface (I/F) 44 that connects the host to bus 36. Peripheral device 28 comprises circuitry 48 that performs the various processing tasks of the peripheral device, a bus I/F 52 connects the peripheral device to bus 36, and a cache memory 56.

Peripheral device 28 may comprise, for example, a network adapter that connects host 24 to a communication network (not shown). Examples of network adapters InfiniBand™ Host Channel Adapters (HCAs) and comprise Ethernet Network Interface Controllers (NICs). Alternatively, the peripheral device may comprise a storage device such as a Solid-State Disk (SSD), a storage controller or storage accelerator, a graphics accelerator such as a Graphics Processing Unit (GPU), an accelerator that offloads the host of certain computational tasks, and/or any other suitable type of peripheral device.

Peripheral bus 36 may comprise, for example, a Peripheral Component Interconnect Express (PCIe) bus, an Advanced Extensible Interface (AXI) bus, a Compute Express Link (CXL) bus, an Nvlink or Nvlink Chip-to-Chip (Nvlink-C2C) bus, or any other suitable type of peripheral bus. Peripheral bus 36 is also referred to as a system bus.

In some embodiments, CPU 40 of host 24 defines one or more memory regions 60 in memory 32. CPU 40 then instructs peripheral device 28 to access (e.g., read and/or write) these memory regions using DMA. In the present example two regions 60 are defined, denoted “REGION X” and “REGION Y”.

Consider, for example, an embodiment in which peripheral device 28 is a network adapter that connects host 24 to a network. In this embodiment, a driver in CPU 40 may store data and metadata for outgoing packets in a memory region 60, and requests peripheral device 28 to construct and send the packets. In response to the request, circuitry 48 of peripheral device 28 reads the data and/or metadata from the specified memory region 60 using DMA (i.e., directly over bus 36 without involving host 24), and constructs and sends the packets.

As another example, in an embodiment in which peripheral device 28 is a storage device, CPU 40 may request peripheral device to read certain data from storage and write the data to one of regions 60 in memory 32. In response, circuitry 48 of peripheral device 28 retrieves the requested data from storage and writes the data using DMA to the specified memory region 60 in memory 32. Other examples of memory regions that may be subject to hints are work queues and completion queues.

In order to enable peripheral device 28 to access a given region 60 directly, CPU 40 and circuitry 48 carry out a memory registration process. As part of memory registration, CPU 44 sends circuitry 48 a context 64 for the memory region 60 being registered. Context 64 comprises various metadata that describes the memory region. Context may comprise, for example, a virtual-to-physical address mapping be used when accessing the memory region. The example of FIG. 1 shows two contexts 64, denoted “CONTEXT X” and “CONTEXT Y”, which respectively describe memory regions 60 “REGION X” and “REGION Y”. Circuitry 48 stores contexts 64 locally. Once a memory region 60 has been registered in peripheral device 28, circuitry 48 is able to access the corresponding memory region 60 directly using DMA, including performing the necessary address translations.

The types of address translations (address mappings) specified in contexts 64 may vary depending on system implementation. In some embodiments, access to memory 32 involves a single translation of a Virtual Address (VA) into a Physical Address (PA). In these embodiments, a given context 64 typically stores a single type of address mapping. In other embodiments, e.g., in a virtualized environment, access to memory 32 involves two address translations—A first translation from a Guest Virtual Address (GVA) into a Guest Physical Address (GPA), followed by a second address translation from the GPA to a Physical Address (HPA, also known as Machine Physical Address—MPA or System Physical Address—SPA). In such embodiments, a given context 64 typically stores both types of address mapping.

In some embodiments, in a virtualized environment, peripheral device may be required to access memory 32 using either of two operational modes:
Input/Output Memory Management Unit (I OMMU) translation: In this mode, host 24 comprises an IOMMU. The peripheral device accesses pinned memory bus 36 using the GPA. The access is marked as over UNTRANSLATED, signaling to the IOMMU that additional translation is required. The IOMMU in turn translates the GPA into a HPA and completes the DMA access.
Address Translation Services (ATS): In this mode, an ATS-enabled device peripheral may request translations from the IOMMU through a suitable protocol (e.g., the ATS protocol for PCIe). The peripheral device then caches the translations supplied by the IOMMU in an Address Translation Cache (ATC). Before performing the DMA access, the peripheral device queries the ATC obtain the HPA of the required access, and performs a PCIe request marked as “TRANSLATED”.

In accessing a given memory region 60, circuitry 48 of peripheral device 28 may perform operations such as caching and/or prefetching. In a typical prefetching operation, circuitry 48 predicts one or more addresses in region 60 from which data is likely to be read next, and reads these addresses before receiving an explicit request from host 24. In a typical caching operation, circuitry 48 caches selected portions of data in cache 56, in order to serve future requests for the data from cache 56 instead of from memory 32. Since the size of cache 56 is limited, circuitry 48 typically evicts selected portions of data from cache 56 using suitable eviction criteria.

In some embodiments, caching and prefetching may be applied to portions of contexts 64, not only to portions of data. For example, in many practical cases the size of a context 64 is large, e.g., due to the size of the virtual-to-physical address mapping. In such cases, some or even all of context 64 may be stored in memory 32. Only selected portions of the context (e.g., individual address translations) may be prefetched as needed, and/or cached in cache 56.

Different memory regions 60 may be accessed by host 24 in different manners, i.e., with different usage characteristics. Several non-limiting examples of usage characteristics include the following:
The address pattern with which the memory region is accessed. Examples of patterns may include a sequential and cyclic pattern, a cyclic but non-sequential pattern, a periodic strided pattern, or a random pattern.
The frequency with which the memory region is accessed, e.g., one-time access, low-frequency access (rarely accessed), or high-frequency access (frequently accessed).
The location of the memory in which the memory region resides. Examples of locations may include a neighbor peer device (a device located under the same bus switch), a non-neighbor peer device (a device located under the root complex but not under the same bus switch), a system location (e.g., system memory), or a local memory (within the peripheral device, not requiring communication over bus 36).
The type(s) of memory-access operation(s) being performed, e.g., read-only, write-only, mixed read and write, mostly read, or mostly write.
Mutable/immutable—An indication of whether the system is expected to change the memory translations or not. Characteristics may comprise, for example, pinned (immutable) access or unpinned (mutable) access.

Alternatively, any other suitable usage characteristics can be used. In some embodiments, host 24 defines and stores usage characteristic records 68 for the various memory regions 60. The example of FIG. 1 shows two usage characteristic records 68 denoted “USAGE CHAR X” and “USER CHAR Y” defined for memory regions 60 “REGION X” and “REGION Y”, respectively.

In order to enable peripheral device 28 to optimize its memory-access operations (e.g., caching and/or prefetching), CPU 40 provides circuitry 48 with hints indicative of the usage characteristics of the various memory regions 60. A hint provided for a certain memory region 60 may indicate a single usage characteristic (e.g., “access type is read-only”) or a combination of usage characteristics (e.g., “access type is read-only, and access pattern is random”).

The hint may be provided to peripheral device 28 as part of the initial memory registration of the memory region in question, or at any other time. For a given memory region, CPU 40 may send an updated hint that changes the usage characteristics of the region if necessary. In some embodiments, a given hint may be an “ad-hoc hint” that is valid for a certain time period or for a certain upcoming transaction or group of transactions. An example of such a hint can be “the next N transactions are expected to be read transactions”.

Upon receiving a hint for a certain memory region 60, circuitry 48 sets a memory-access policy for that region based on the hint. In some embodiments, the memory-access policy comprises a caching policy that defines (i) criteria for caching portions of data and/or metadata (e.g., portions of context 64) in cache 56, and/or criteria for evicting portions of data and/or metadata from cache 56. Additionally, or alternatively, the memory-access policy comprises a prefetching policy that defines criteria for prefetching portions of data and/or metadata from memory 32 to peripheral device 28.

As another example, when using ATS, circuitry 48 may prefetch address translation requests, in which case a prefetching policy may be defined based on hints for this sort of prefetching as well. Additionally or alternatively, a caching policy for caching address translations in the ATC may be defined based on hints. Further additionally or alternatively, the memory-access policy may comprise any other suitable policy.

In various embodiments, circuitry 48 may use any suitable technique for setting a memory-access policy for a memory region 60 based on a received hint. In the embodiment of FIG. 1, circuitry 48 holds a hint list 72 specifying a pool of possible hints, and a policy list 76 specifying a pool of possible memory-access policies. Circuitry 48 also stores a mapping (shown as arrows in the figure) that maps between hints on hint list 72 and policies on policy list 76. Generally, a given hint may be mapped to one or more policies, and a given policy may be mapped to one or more hints. Upon receiving a hint from CPU 40, circuitry 48 looks-up hint list 72, finds the record of hint list 72 that matches the received hint, and sets the memory-access policy (or policies) mapped to this hint record.

In some embodiments, circuitry 48 of peripheral device 28 may comprise a policy enforcer (not seen in the figure) that is configured to enforce the memory-access policies.

The configuration of system 20, including the configurations of host 24, peripheral device 28 and memory 32, are example configurations that are chosen purely for the sake of conceptual clarity. Any other suitable configurations can be used in alternative embodiments. For example, in some embodiments host 24 does not send hints to peripheral device 28. Instead, circuitry 48 in peripheral device 28 learns the usage characteristics of one or more memory regions 60 by monitoring memory-access transactions performed in memory 32. For example, circuitry 48 may track the addresses being accessed in the memory region, to determine whether the access pattern is sequential or random. As another example, circuitry 48 may track the times or frequencies of access to the memory region, to decide whether the memory region should be regarded as frequently-accessed or rarely-accessed.

As another example, in the embodiment of FIG. 1 the memory regions are defined, and hints are sent, by CPU 40 of host 24. In alternative embodiments, memory regions may be defined, and hints may be sent, by any other suitable processing device. Examples of processing devices include a CPU, a GPU, and a peer device such as a Field-Programmable Gate Array (FPGA). The embodiments described herein refer mainly to a host, by way of example.

In yet other embodiments, circuitry 48 may use a hybrid method that sets a memory-access policy for a memory region based on a combination of hint(s) and self-learning. As another example, circuitry 48 may set one memory-access policy based on hinting, and another memory-access policy, for the same memory region or for a different memory region, based on self-learning.

As yet another example, the disclosed techniques do not mandate the use of memory registration for defining a memory region 60. For example, a memory region may simply be a range of addresses being accessed by the peripheral device. In example embodiments, peripheral device 28 may access memory 32 using techniques such as “implicit On-Demand Paging” (implicit-ODP), Unified Virtual Memory (UVM), or Shared Virtual Addressing (SVA), all of which do not require memory registration. In such embodiments, circuitry 48 in peripheral device 28 may allocate a context 64 per address range which has a particular usage characteristic. The boundaries of the memory region, and/or the applicable usage characteristic, may be either explicitly declared, or implicitly self-learned.

When using schemes such as ODP, SVA and UVM, a memory page may not be pinned to the host memory, and may therefore be swapped-out to disk, and later swapped-in to a different memory location. When using such schemes, a hint may also be indicative of how likely it is that the relevant memory is present on the host (or on a swap device). When using a swap device, circuitry 48 may issue an early paging request, e.g., using the PCIe Page Request Interface (PRI) or using vendor specific event. Such an early request is also regarded herein as a kind of prefetching, and prefetching policies for memory pages may therefore be defined based on hints.

### Methods for Setting Memory-Access Policies in Peripheral Device

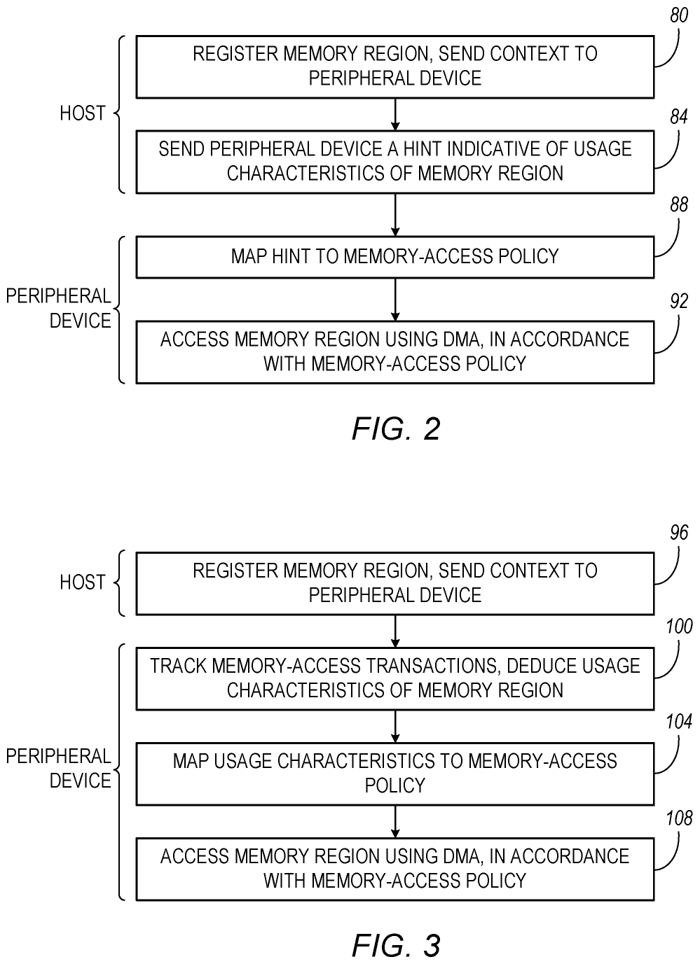

FIG. 2 is a flow chart that schematically illustrates a method for setting a memory-access policy in peripheral device 28, in accordance with an embodiment of the present invention. The method begins with CPU 40 of host 24 registering a certain memory region 60, at a memory registration stage 80. As part of the memory registration process, CPU 40 specifies a context 64 for the memory region. The context may comprise, for example, the range of addresses of memory 32 included in the applicable virtual-to-physical memory region 60, any translations, and/or any other address translation or suitable metadata. CPU 40 sends the context 64 to circuitry 48 of peripheral device 28.

At a hinting stage 84, CPU 40 sends circuitry 48 a hint that is indicative one or more usage characteristics of the memory region in question. At a mapping stage 88, circuitry 48 maps the received hint to a corresponding memory-access policy. In an example embodiment, circuitry 48 uses hint list 72, policy list 76, and the mapping between them (FIG. 1) to select the appropriate memory-access policy. At a memory access stage 92, circuitry 48 accesses the memory region in question (in memory 32) using the selected memory-access policy.

FIG. 3 is a flow chart that schematically illustrates a method for setting a memory-access policy in peripheral device 28, in accordance with an alternative embodiment of the present invention. Unlike the method of FIG. 2 above, the method of FIG. 3 involves self-learning of a memory region's usage pattern instead of hints.

The method begins with a memory registration stage 96, similar to stage 80 of FIG. 2. At a usage-pattern learning stage 100, circuitry 48 of peripheral device 28 tracks memory-access transactions (e.g., read and/or write transactions) performed in the memory region in question. Based on the tracked transactions, circuitry 48 deduces one or more usage patterns for the memory region, e.g., whether the access pattern is random or sequential, whether the memory region is accessed once, rarely or frequently, etc.

At a policy setting stage 104, circuitry 48 maps the deduced usage pattern to a suitable memory-access policy. As one illustrative example, in response to deciding that the memory region in question is accessed only once or rarely, circuitry 48 may decide to set a “no caching” policy for the memory region. If, on the other hand, the memory region appears to be accessed very frequently, circuitry 48 may give preference to caching of data for this memory region.

At a memory access stage 108, circuitry 48 accesses region using the selected memory-access the memory policy.

In various embodiments, peripheral device 28 may use any suitable mapping between hints (in the case of FIG. 1) or usage characteristics (in the case of FIG. 3) and memory-access policies. Several non-limiting examples are given in the table below:

TABLE 1
Example Hint/Usage-characteristic→policy mappings

| Hint/Usage characteristic | Memory-access policy |
|---|---|
| Random access | Do not prefetch |
| Sequential access | Prefetch |
| Rarely accessed/accessed | Do not cache |
| once | |
| Frequently accessed | Cache |
| Latency sensitive | Data/control Low eviction |
| | priority, |
| | Data cache stashing |
| Context has been updated | Prefetch |
| (memory region likely to be | |
| used soon) | |
| Often non-present | Pre-issue page requests |

### Additional Embodiments and Variations

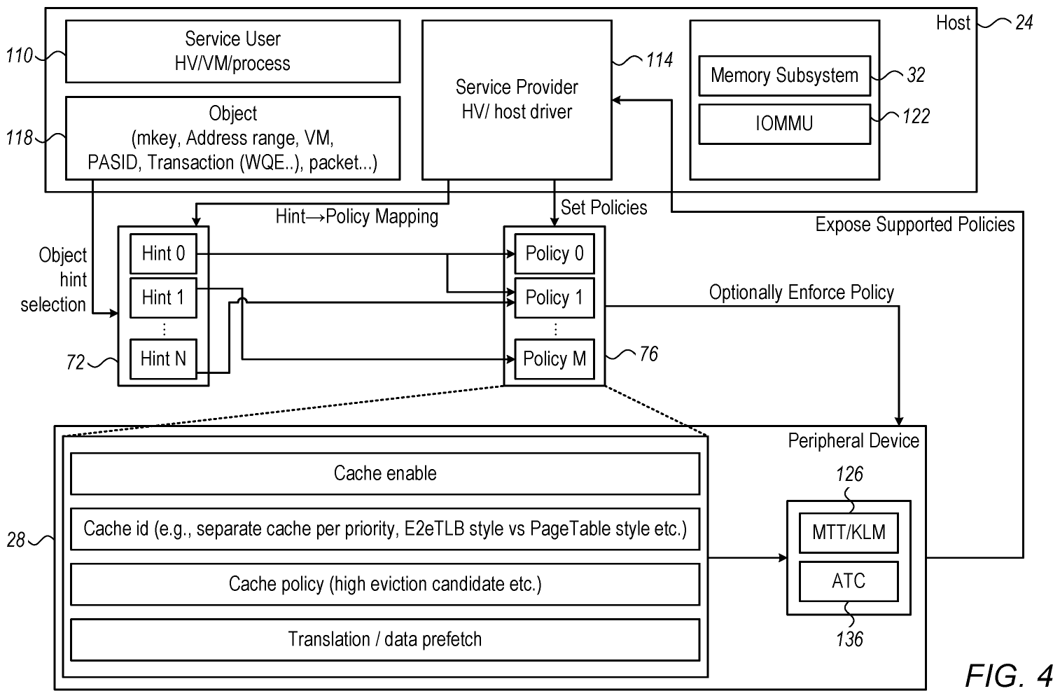

FIG. 4 is a block diagram that schematically illustrates additional details of host 24 and peripheral device 28, and of setting memory-access policies, in accordance with an embodiment of the present invention. In the present example, memory 32 (denoted “memory subsystem” in the figure) is part of host 24. The system is a virtualized system that comprises both (i) an IOMMU 122 in host 24 and (ii) ATS using an ATC 136 in peripheral device 28.

In the embodiment of FIG. 4, the software running on host 24 comprises (i) one or more service users 110 and (ii) a service provider 114. A given service user 110 may comprise any suitable user software, e.g., I/O driver, that issues memory-access commands to memory subsystem 32. Examples of service users include a Virtual Machine (VM), a hypervisor (HV) that manages VMs, a “bare-metal” process, a container, etc. A service user 110 may have passthrough capabilities, i.e., it may issue certain control path and data path commands to peripheral device 28 directly. Service provider 114 comprises a privileged entity (e.g., a HV, a host driver, or on-device software such as software running on a controller in the peripheral device) which is permitted to control peripheral device 28 at the system level, e.g., at the level of the entire physical host. Service provider 114 may comprise, for example, a bare-metal host driver or a HV device driver.

Service users 110 may create device-specific memory objects 118 that provide peripheral device 28 with metadata relating to memory regions 60. The metadata in objects 118 may comprise, for example, address ranges, virtual-to-physical address translations (e.g., VA-to-GPA or VA-to-HPA depending on the use-case, as described above), ATS entries, Memory Translation Tables (MTT), memory keys (mkey), Process Address Space IDs (PASID), and/or any other suitable information. Peripheral device 28 uses the metadata in objects 118, and locally-stored Memory Translation Tables (MTTs) 126, to map memory regions of the application virtual memory space (or device driver physical memory space) to physical memory space, whether HPA or GPA. In some embodiments the address translations are defined using indirection, e.g., using one mkey that points to one or more other mkey's. This structure is denoted “KLM” in the figure.

In some embodiments, hints and usage characteristics are defined at finer granularity than an entire memory region. For example, for a given memory region, different usage characteristics and/or different hints may be defined per VM, per bus transaction, per Work-Queue Element (WQE), per packet, per address range within a memory region, etc.

In some embodiments, some objects 118 may comprise hints that are indicative of the usage characteristics of the memory regions they address, as described above. In some embodiments, service provider 114 may set memory-access policies, to be applied by peripheral device 28 on objects 118. In the present example, service provider 114 provides peripheral device 28 with hint list 72, policy list 76, and a hint→policy mapping that maps the hints to the policies.

As noted above, peripheral device 28 may comprise a policy enforcer (not seen in the figure) that optionally enforces the memory-access policies. The term “optionally” in this context means that the policy enforcer has the option of overriding, changing or ignoring the request to enforce a certain policy. For example, the policy enforcer may be requested to enforce a certain policy as a result of a hint, but at the same time self-learn that the actual usage characteristics of the memory region in question do not match the requested policy. In such a case, the policy enforcer may decide to enforce a different policy than requested, or to refrain from enforcing any of the policies. The policy enforcer may apply such decisions for the single mismatched memory region, for all memory regions supplied by the service user with this hint, for all hints supplied by the service user, etc.

The policy enforcer may expose the supported policies as capabilities to service provider 114. In an embodiment, service provider 114 specifies hint list 72, policy list 76 and the hint→policy mapping based on the supported policies, as reported by peripheral device 28.

An inset at the bottom of FIG. 4 lists examples of possible memory-access policies and their attributes. Such examples include, but are not limited to, the following:
Cache enable: An indication of whether to cache an entry (comprising context or data) in a low-level cache or not.
Cache id: An indication of which type of cache to use for a specific object (e.g., cache per priority, end-to-end cache—supply end-to-end lookup for indirection objects, page table lookup cache, flat lookup cache, etc.).
Caching policy—defining high/low eviction priority.
Preprocessing—perform some action involving the memory object before actual transactions, which use the object, are issued to the peripheral device. Preprocessing actions may comprise prefetching of contexts or relevant address translations, or performing ATS requests or paging requests ahead of time. Note that in the present context, the term “prefetching an address translation” refers to either fetching a translation that was already performed, or performing a translation (e.g., serving an ATS request) and returning the resulting translation.

Another example of a memory-access policy is a policy that determines attributes of the system bus transactions themselves. For example, PCIe Transaction Layer Packets (TLPs) contain Processing Hint (PH) and steering tag fields. These attributes may have an impact on target memory caching behavior. One example is “cache stashing”: Hints can be provided to inject data directly into L2 or L1 processing device caches, instead of to system level cache or DRAM. This sort of policy is also regarded herein as a kind of caching policy.

The configurations of system 20, including the configurations of host 24, peripheral device 28 and memory 32, as shown in FIGS. 1 and 4, are example configurations that are chosen purely for the sake of conceptual clarity. In alternative embodiments, any other suitable configurations can be used. Elements that are not necessary for understanding the principles of the present invention have been omitted from the figures for clarity.

The various elements of host 24 and peripheral device 28 may be implemented in hardware, e.g., in one or more Application-Specific Integrated Circuits (ASICs) or FPGAs, in software, or using a combination of hardware and software elements. In some embodiments, certain functions, e.g., some or all functions of CPU 40 and/or circuitry 48, may be implemented using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Although the embodiments described herein mainly address DMA transactions, the methods and systems described herein can also be used in other applications, such as in Remote DMA (RDMA). In such applications, host 24 and memory 32 may be remote from one another (i.e., over a network), or host 24 and peripheral device 28 may be remote from one another, or peripheral device 28 and memory 32 may be remote from one another. As another example, in RDMA applications the host that performs memory registration is not necessarily the same host that issues hints for that memory region.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a processing device, to assign a memory region in a memory; and
a peripheral device, to set a memory-access policy responsively to usage characteristics of the memory region, and to access data in the memory region using Direct Memory Access (DMA) in accordance with the memory-access policy.

2. The system according to claim 1, wherein the processing device is to provide to the peripheral device context information describing the memory region, and wherein the peripheral device is to access data in the memory region in accordance with the context information.

3. The system according to claim 1, wherein the memory-access policy specifies a caching policy for caching, in the peripheral device, portions of the data or portions of context information describing the memory region.

4. The system according to claim 1, wherein the memory-access policy specifies a prefetching policy for prefetching, in the peripheral device, portions of the data or portions of context information describing the memory region.

5. The system according to claim 1, wherein the usage characteristics comprise one or more of:
a pattern of addresses that characterizes access to the memory region;
an access frequency that characterizes access to the memory region;
an access direction that characterizes access to the memory region;
a location of the memory region; and
whether the memory region is pinned or unpinned.

6. The system according to claim 1, wherein the peripheral device is to deduce the usage characteristics by tracking memory-access transactions performed in the memory region.

7. The system according to claim 1, wherein the processing device is to generate a hint that is indicative of the usage characteristics of the memory region and to provide the hint to the peripheral device, and wherein the peripheral device is to set the memory-access policy responsively to the hint.

8. The system according to claim 7, wherein the processing device is to select the hint from a defined set of hints, and wherein the peripheral device is to select the memory-access policy from a defined set of memory-access policies.

9. The system according to claim 8, wherein one or both of the processing device and the peripheral device are to adaptively modify one or more of:
one or more of the hints;
one or more of the memory-access policies; and
a mapping between the hints and the memory-access policies.

10. The system according to claim 7, wherein the memory-access policy, and a mapping between the hint and the memory-access policy, are internal to the peripheral device and are not accessible to the processing device.

11. The system according to claim 7, wherein one or both of the processing device and the peripheral device are to provide an Application Programming Interface (API) for specifying one or more of:
the hint;
the memory-access policy; and
a mapping between the hint and the memory-access policy.

12. The system according to claim 7, wherein the hint is an ad-hoc hint that is valid for a defined time period or for one or more memory-access transactions to be performed in the memory region.

13. A method, comprising:
using a processing device, assigning a memory region in a memory; and
in a peripheral device, setting a memory-access policy responsively to usage characteristics of the memory region, and accessing data in the memory region using Direct Memory Access (DMA) in accordance with the memory-access policy.

14. The method according to claim 13, further comprising providing from the processing device to the peripheral device context information describing the memory region, wherein accessing data in the memory region is performed in accordance with the context information.

15. The method according to claim 13, wherein the memory-access policy specifies a caching policy for caching, in the peripheral device, portions of the data or portions of context information describing the memory region.

16. The method according to claim 13, wherein the memory-access policy specifies a prefetching policy for prefetching, in the peripheral device, portions of the data or portions of context information describing the memory region.

17. The method according to claim 13, wherein the usage characteristics comprise one or more of:
a pattern of addresses that characterizes access to the memory region;
an access frequency that characterizes access to the memory region;
an access direction that characterizes access to the memory region;
a location of the memory region; and
whether the memory region is pinned or unpinned.

18. The method according to claim 13, further comprising deducing the usage characteristics by the peripheral device, by tracking memory-access transactions performed in the memory region.

19. The method according to claim 13, further comprising generating, by the processing device, a hint that is indicative of the usage characteristics of the memory region, and providing the hint from the processing device to the peripheral device, wherein setting the memory-access policy is performed responsively to the hint.

20. The method according to claim 19, wherein generating the hint comprises selecting the hint from a defined set of hints, and wherein setting the memory-access policy comprises selecting the memory-access policy from a defined set of memory-access policies.

21. The method according to claim 20, further comprising adaptively modifying one or more of:
one or more of the hints;
one or more of the memory-access policies; and
a mapping between the hints and the memory-access policies.

22. The method according to claim 19, wherein the memory-access policy, and a mapping between the hint and the memory-access policy, are internal to the peripheral device and are not accessible to the processing device.

23. The method according to claim 19, further comprising providing an Application Programming Interface (API) for specifying one or more of:
the hint;
the memory-access policy; and
a mapping between the hint and the memory-access policy.

24. The method according to claim 19, wherein the hint is an ad-hoc hint that is valid for a defined time period or for one or more memory-access transactions to be performed in the memory region.
